(19) United States
(12) Patent Application Publication
(10) Pub. No.: US 2012/0239481 A1
(43) Pub. Date: Sep. 20, 2012

(54) DIGITAL SHOEBOX

(75) Inventors: Steve Yankovich, San Jose, CA (US); Ryan Melcher, Ben Lomond, CA (US); Robert Dean Veres, Evanston, IL (US)

(73) Assignee: eBay Inc., San Jose, CA (US)

(21) Appl. No.: 13/050,751

(22) Filed: Mar. 17, 2011

(51) Int. Cl. G06Q 30/00; G06F 17/30

(52) U.S. Cl. 705/14.25; 707/769; 707/E17.014

(57) ABSTRACT

A method and a system stores records of financial transactions from a user in a centralized location. A processor-implemented receipt module receives a record of a financial transaction from a mobile device. A processor-implemented item identification module identifies an item from the record of the financial transaction. A processor-implemented catalog module retrieves data corresponding to the identified item. A storage device stores the record of the financial transaction associated with the identified item along with the corresponding data.

### TECHNICAL FIELD

Example embodiments disclosed in this application generally relate to a method and system for managing items, and more specifically, to a method and system for collecting receipts of purchased items in a centralized location and for determining targeted incentives based on the items in the stored receipts.

### BACKGROUND

Most financial transactions entail a merchant generating a receipt for a buyer. Many times these receipts are lost, torn, faded, or discarded. These receipts are often required or desired to be kept in readable condition for a variety of reasons.

Individuals desire to keep their receipts in case they want to return or exchange an item they purchased from a merchant. Often, the receipts are misplaced, lost or damaged, thereby making it difficult to return the item. Another reason for keeping receipts is for claiming special rebates or warranties. Copies of the receipts are required as proof of purchase to the manufacturer or sponsor of a promotion. Receipts can also be collected in order to keep track of cash and credit expenditures for budgetary purposes.

### BRIEF DESCRIPTION OF THE DRAWINGS

The present invention is illustrated by way of example, and not by way of limitation, in the figures of the accompanying drawings in which:

FIG. 1 is a network diagram depicting a network system, according to one embodiment, having a client-server architecture configured for exchanging data over a network;

FIG. 2 is a block diagram illustrating an example embodiment of a transaction recorder application;

FIG. 3 is a block diagram illustrating an example embodiment of a location identification module;

FIG. 4 is a block diagram illustrating an example embodiment of an item identification module;

FIG. 5 is a block diagram illustrating an example embodiment of a receipt module;

FIG. 6 is a block diagram illustrating an example embodiment of a catalog module;

FIG. 7 is a block diagram illustrating an example embodiment of a notification module;

FIG. 8A is a block diagram illustrating an example embodiment of an incentive module.

FIG. 8B is a block diagram illustrating another example embodiment of an incentive module.

FIG. 9 is a block diagram illustrating an example embodiment of a listing generator module.

FIG. 10 is a block diagram illustrating attributes of a data structure for the transaction recorder application;

FIG. 11 is a flow chart of an example method for storing a record of a financial transaction;

FIG. 12 is a flow chart of an example method for communicating updates;

FIG. 13 is a flow chart of an example method for communicating incentives;

FIG. 14 is a flow chart of another example method for communicating incentives;

FIG. 15 is a flow chart of an example method for generating a listing; and

FIG. 16 shows a diagrammatic representation of machine in the example form of a computer system within which a set of instructions may be executed to cause the machine to perform any one or more of the methodologies discussed herein.

### DETAILED DESCRIPTION

Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

In various embodiments, a method and a system store records of financial transactions and associated content in a centralized location for a user to be notified of new versions or updates for products identified in the transaction records and to receive incentives such as coupons on related products. The system may act as a digital shoebox where all receipts are stored in one central location for the user to access. The digital shoebox may be integrated with e-commerce platforms to allow the user to export information and generate a listing for an item in his inventory.

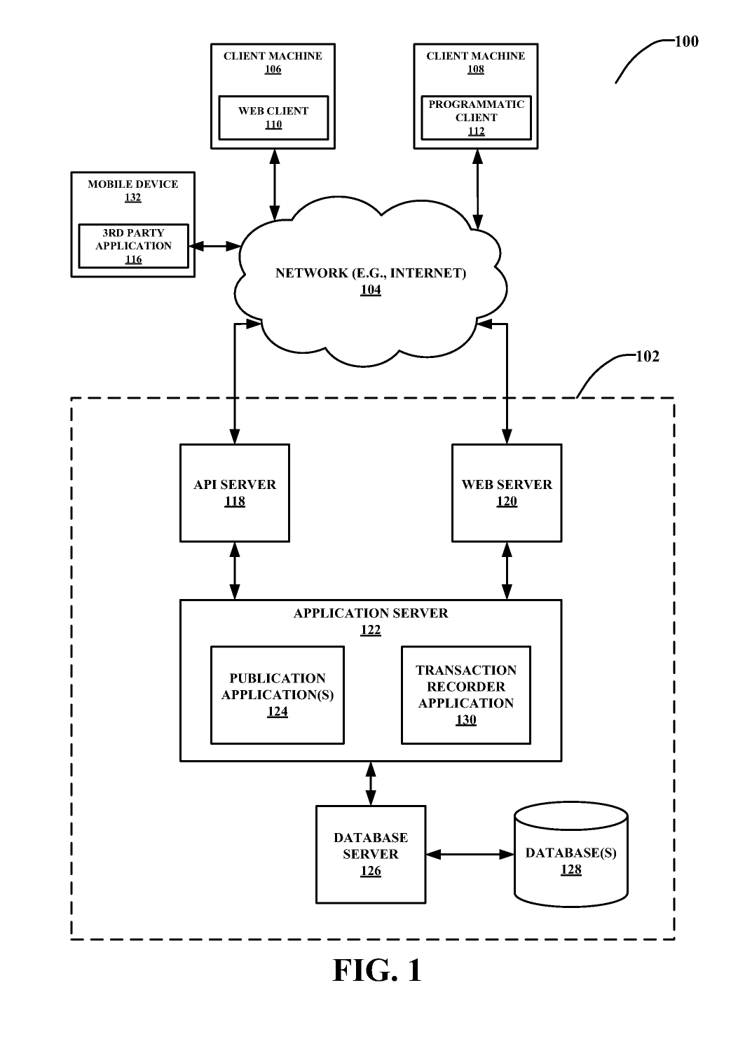

FIG. 1 is a network diagram depicting a network system 100, according to one embodiment, having a client-server architecture configured for exchanging data over a network. For example, the network system 100 may be a publication/publisher system 102 where clients may communicate and exchange data within the network system 100. The data may pertain to various functions (e.g., online item purchases) and aspects (e.g., managing content and user reputation values) associated with the network system 100 and its users. Although illustrated herein as a client-server architecture as an example, other embodiments may include other network architectures, such as a peer-to-peer or distributed network environment.

A data exchange platform, in an example form of a network-based publisher 102, may provide server-side functionality, via a network 104 (e.g., the Internet) to one or more clients. The one or more clients may include users that utilize the network system 100 and more specifically, the network-based publisher 102, to exchange data over the network 114. These transactions may include transmitting, receiving (communicating) and processing data to, from, and regarding content and users of the network system 100. The data may include, but are not limited to, content and user data such as feedback data; user reputation values; user profiles; user attributes; product and service reviews; product, service, manufacture, and vendor recommendations and identifiers; product and service listings associated with buyers and sellers; auction bids; and transaction data, among other things.

In various embodiments, the data exchanges within the network system 100 may be dependent upon user-selected functions available through one or more client or user interfaces (UIs). The UIs may be associated with a client machine, such as a client machine 106 using a web client 110. The web client 110 may be in communication with the network-based publisher 102 via a web server 120. The UIs may also be associated with a client machine 108 using a programmatic client 112, such as a client application, or a third party server 114 hosting a third party application 116. It can be appreciated in various embodiments the client machine 106, 108, or third party application 114 may be associated with a buyer, a seller, a third party electronic commerce platform, a payment service provider, or a shipping service provider, each in communication with the network-based publisher 102 and optionally each other. The buyers and sellers may be any one of individuals, merchants, or service providers, among other things.

A mobile device 132 may also be in communication with the network-based publisher 102 via a web server 120. The mobile device 132 may include a portable electronic device providing at least some of the functionalities of the client machines 106 and 108. The mobile device 132 may include a third party application 116 (or a web client) configured communicate with application server 122.

Turning specifically to the network-based publisher 102, an application program interface (API) server 118 and a web server 120 are coupled to, and provide programmatic and web interfaces respectively to, one or more application servers 122. The application servers 122 host one or more publication application (s) 124. The application servers 122 are, in turn, shown to be coupled to one or more database server(s) 126 that facilitate access to one or more database(s) 128.

In one embodiment, the web server 120 and the API server 118 communicate and receive data pertaining to items, listings, transactions, and feedback, among other things, via various user input tools. For example, the web server 120 may send and receive data to and from a toolbar or webpage on a browser application (e.g., web client 110) operating on a client machine (e.g., client machine 106). The API server 118 may send and receive data to and from an application (e.g., client application 112 or third party application 116) running on another client machine (e.g., client machine 108 or third party server 114).

A publication application(s) 124 may provide a number of publisher functions and services (e.g., listing, payment, etc.) to users that access the network-based publisher 102. For example, the publication application(s) 124 may provide a number of services and functions to users for listing goods and/or services for sale, facilitating transactions, and reviewing and providing feedback about transactions and associated users. Additionally, the publication application(s) 124 may track and store data and metadata relating to listings, transactions, and user interaction with the network-based publisher 102.

FIG. 1 also illustrates a third party application 116 that may execute on a third party server 114 and may have programmatic access to the network-based publisher 102 via the programmatic interface provided by the API server 118. For example, the third party application 116 may use information retrieved from the network-based publisher 102 to support one or more features or functions on a website hosted by the third party. The third party website may, for example, provide one or more listing, feedback, publisher or payment functions that are supported by the relevant applications of the network-based publisher 102.

The application server 122 also includes a transaction recorder application 130. The transaction recorder application 130 stores financial transactions records and associated content in a centralized location for the user to be notified of new versions or updates for products identified in the transaction records and to receive incentives such as coupons. The transaction recorder application 130 also may facilitate the sale of user-owned or user-purchased items via the network-based publisher 102 through the maintenance of financial records (e.g., receipts, proofs of purchase) that may be used to generate a listing for a user-owned item.

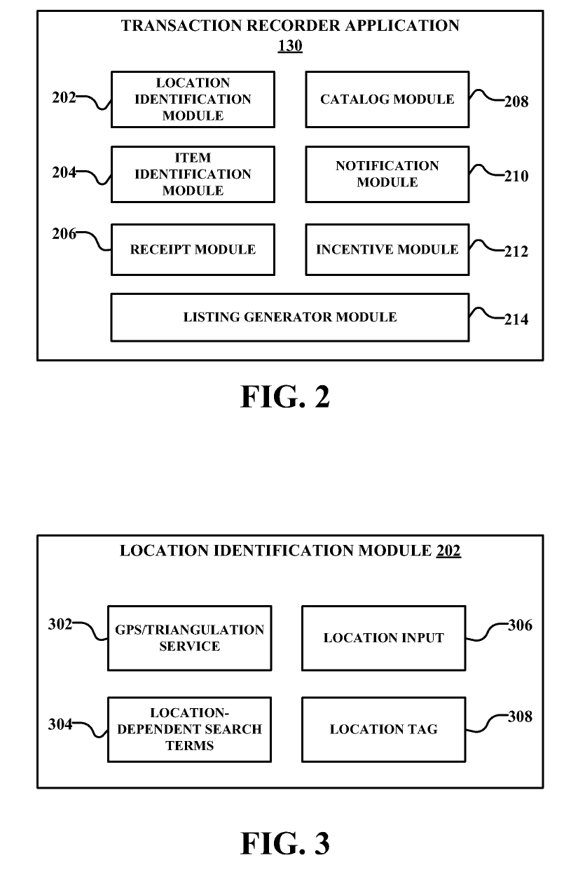

FIG. 2 is a block diagram illustrating an example embodiment of a transaction recorder application 130, which may be provided as part of the network-based publisher 102 or maybe a standalone application within application server 122. The transaction recorder application 130 includes a location identification module 202, an item identification module 204, a receipt module 206, a catalog module 208, a notification module 210, an incentive module 212, and a listing generator module 214. The location identification module 202 determines a geographic location of the mobile device 132. The item identification module 204 identifies an item specified by the user from the mobile device 132. The receipt module 206 receives a record of a financial transaction (e.g. a copy or picture of the receipt) from the mobile device 132. The catalog module 208 retrieves data corresponding to the identified item from a library of items catalog. The notification module 210 notifies the user of updated data (e.g. software update, manufacturer's recall, etc. . . . ) related to the identified item. The incentive module 212 retrieves an incentive for an item related to the identified item (e.g. accessories, new models, related models). The listing generator 214 generates a listing of the identified item to be transmitted to the publication application 124. Each of the aforementioned modules (and any components or sub-modules thereof) may be implemented in hardware, software, firmware, or a combination thereof. For example, the modules may be implemented by one or more processors.

FIG. 3 is a block diagram illustrating an example embodiment of the location identification module 202. The location of the mobile device 132 can be determined in many ways. For example, the mobile device 132 may be equipped with a Global Positioning Service (GPS) system that would allow the mobile device to communicate the coordinates or location of the mobile device 132 to a GPS/triangulation module 302 of the location identification module 202. In another example, the location of the mobile device 132 may be determined by triangulation using wireless communication towers and/or wireless nodes (e.g. cell phone towers, wi-fi hotspots) within wireless signal reach of the mobile device 132. Based on the geographic coordinates, the GPS/triangulation module 302 of the location identification module 202 can determine the geographic location of the mobile device 132 after correlating the received coordinates to a map. Furthermore, the general location of the mobile device 132 can be located when the user of the mobile device 132 logs onto a local internet connection, for example, at a hotel or coffee shop. In an example embodiment, the location identification module 202 may interface with third party applications or modules executing on the mobile device 132 that track the location of the mobile device 132. For example, a user may “check in” at a particular location (e.g., a store, landmark, building, park) using a third party application. The location identification module 202 may interface with the third party application and obtain the location at which the user has “checked in.”

The location identification module 202 may also include a location input module 306 configured to determine a geographic location of the mobile device 132 by requesting the user to input an address, city, zip code or other location information in the mobile device 132. In one embodiment, the user can select a location from a list of locations or a map on the mobile device 132. For example, a user on the mobile device 132 inputs the location of the mobile device 132 via an application or a web browser on the mobile device 132.

The location identification module 202 may also include a location-dependent search term module 304. The location of the mobile device 132 can be inferred when the user of the mobile device 132 request a search on the mobile device 132 using location-dependent search terms. For example, a user inputs a search on his/her mobile device for “Best Japanese Restaurant San Jose.” The location-dependent search term module 304 consults a database (not shown) that can determine the geographic location of the highly ranked Japanese restaurant in San Jose. The location-dependent search term module 304 then infers that the user of the mobile device 132 is at that geographic location. In an example embodiment, the location-dependent search term module 304 may infer the location of the user based on the search terms submitted by the user and irrespective of the search results or whether the user actually conducts the search. Using the foregoing example, the location-dependent search term module 304 may parse the search query entered by the user and infer that the user is located in or around San Jose.

The location identification module 202 may also include a tag module 308 configured to determine the geographic location of the mobile device 132 based on a tag associated with a unique geographic location. The tag may include for example, a barcode tag, such as a linear barcode, QR barcode, or other two-dimensional (2D) barcode, a Radio Frequency Identification (RFID) tag that is associated with a unique geographic location. For example, a user of the mobile device 132 may use his/her mobile device to scan the tag placed at a landmark or store. The tag is uniquely associated with the geographic location of the landmark or store. Such relationship between the unique tag and the unique geographic location is stored in a tag map database (not shown). The tag module 308 can then determine the geographic location of the mobile device 132 based on the tag after consulting the tag map database.

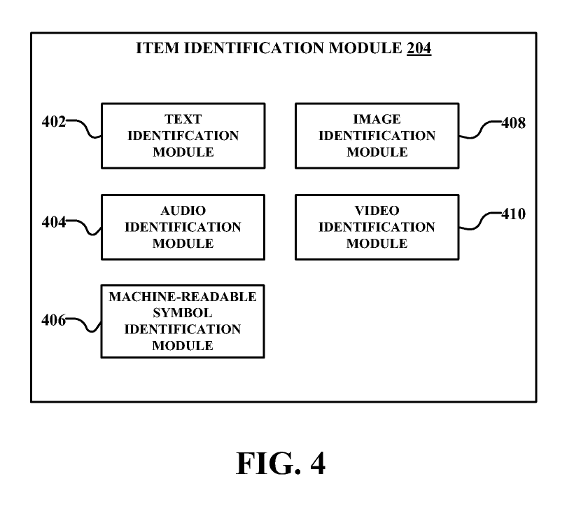

FIG. 4 is a block diagram illustrating an example embodiment of an item identification module 204. The item purchased by the user of the mobile device 132 can be determined in many ways using any of the following examples of modules: a text identification module 402, an audio identification module 404, a machine-readable symbol module 406, an image identification module 408, and a video identification module 410.

The text identification module 402 is configured to identify an item purchased by the user of the mobile device 132 using a text input from the user at the mobile device 132. For example, the user may enter the brand name and model number, among other things, of the item that the user just purchased at the location of the mobile device 132. The text identification module 402 can identify the item by comparing the brand name and model number of the item with a database containing a catalog of products.

In another embodiment, the user can enter the Universal Product Code (UPC) code or any other machine-readable code associated with an item. The text identification module 402 can then identify the item by comparing the UPC code with a database containing a catalog of products and their corresponding UPC code(s).

The audio identification module 404 is configured to identify an item purchased by the user of the mobile device 132 using an audio input from the user at the mobile device 132. For example, the user may say the brand name, model number, and purchased price, among other things, of an item the user just purchased. The audio identification module 404 includes a speech recognition system (not shown) that enables the spoken words of the user to be transcribed into text.

The audio identification module 404 then can be used to identify the purchased item by comparing the brand name and model number, among other things, of the item transcribed from the audio with a database containing a catalog of products. A matching item record may be identified and retrieved from the database using the transcribed text.

The machine-readable symbol module 406 is configured to identify an item by having the user scan the bar code or any other machine-readable symbol on the item with his/her mobile device 132 acting as a machine-readable symbol reader. For example, the mobile device 132 may include an optical device (e.g., a lens, a camera) configured to capture an image of a bar code on an item or product. The image may be captured as a picture or as one or more video frames. The mobile device 132 may then upload the captured image to the machine-readable symbol module 406. The machine-readable symbol module 406 processes the machine-readable symbol by consulting a database of machine-readable symbols to match the machine-readable symbol with a corresponding item or product. The machine-readable symbol module 406 can then identify the item purchased by the user. Based on the identified item, the machine-readable symbol module 406 can further determine attributes associated with the item. For example, the machine-readable symbol module 406 can determine the category, brand name, and other products related or similar to the identified item.

The image identification module 408 is configured to identify an item by having the user take a picture of the item with his/her mobile device 132. Mobile devices commonly have an optical lens to capture images. The mobile device 132 may then upload the picture to the image identification module 408. The image identification module 408 analyzes the picture using an image recognition algorithm (not shown) to match the uploaded picture with a corresponding image of an item. The image recognition algorithm consults a database of product images and corresponding items to identify the uploaded picture. For example, a user may take a picture of a shoe with his/her mobile device. The image identification module 408 recognizes the shoe and identifies its brand and model, among other things. Other attributes identified by the image identification module 408 may include the color of the shoe, the size and/or dimensions of the shoe, and identifying features of the shoe (e.g., stripes, logos, tassles, laces).

The video identification module 410 is configured to identify an item by having the user take a video of the item with his/her mobile device 132. Mobile devices commonly have an optical lens to capture video. The mobile device 132 may then upload the video (or a portion of the video) to the video identification module 408. The video identification module 410 analyzes the frames of the video using an image recognition algorithm (not shown) to identify an item contained in a frame of the video. The image recognition algorithm consults a database of images and corresponding items to identify the item in the uploaded video. For example, a user may take a video using his/her mobile device 132 of a shoe belonging to a person walking. The video identification module 410 recognizes the shoe and identifies its brand name and model, among other things.

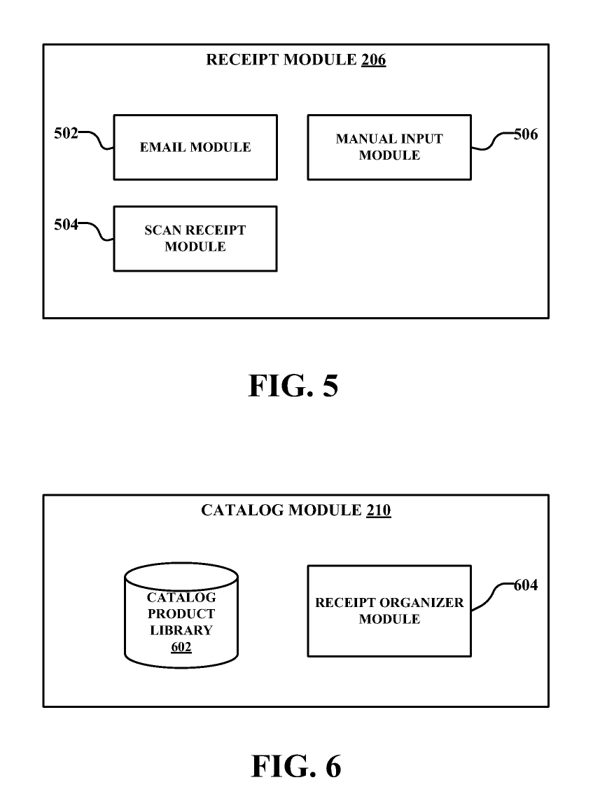

FIG. 5 is a block diagram illustrating an example embodiment of the receipt module 206. The receipt module 206 includes an email module 502, a scan module 504, and an input module 506.

The email module 502 receives an electronic receipt from the user of the mobile device 132. For example, the user purchases an item online and receives via email an electronic copy of the receipt or invoice. The user may then forward the email to an email account associated with the user. The email module 502 receives the copy of the receipt at the unique email account and stores the receipt in a centralized storage device. As such, all receipts received at the email module 502 are stored in the centralized storage device where the user can have access to them anytime. The term “centralized” means that the user does not have to access several websites or different entities to retrieve his receipts. The user can log onto one single website that would allow him/her to retrieve all this receipts. Those of ordinary skills in the art will recognize that the single website and the receipts may reside across several networked storage devices. The email module 502 also may receive an electronic receipt from a merchant or seller from whom the user purchases or transacts for an item. As part of the transaction or subsequent to the transaction, the merchant or seller may transmit a digital copy of the transaction receipt to the email account associated with the centralized storage device.

The scan receipt module 504 receives a picture of the receipt from the mobile device 132. For example, the mobile device 132 may include an optical device (e.g., a lens, a camera) configured to capture an image of the receipt for a purchased item or product. The mobile device 132 may then upload the captured image to scan receipt module 504. The scan receipt module 504 processes the captured image of the receipt to extract, among other things, the brand name, model, price, date of purchase, and location of purchase using, for example, an optical character recognition (OCR) algorithm. The scan receipt module 504 can then identify the item purchased by the user. Based on the identified item, the scan receipt module 504 can further determine attributes (warranty terms, manuals, notices, recalls, and so forth) associated with the purchased item by consulting a database of products.

The input module 506 is configured to receive a manual entry from the user about a purchased item. The input module 506 receives an identification of an item purchased by the user of the mobile device 132 with the purchase price and date of purchase using a text input from the user at the mobile device 132. For example, the user may enter the brand name, model number (or a UPC code), and purchase price of an item the user just purchased at the location of the mobile device 132.

FIG. 6 is a block diagram illustrating an example embodiment of the catalog module 208. A library of catalog products/items 602 stores data associated with corresponding products. For example, the library 602 may store UPC codes, brand names, model numbers, specifications, warranty terms, manuals, and so forth.

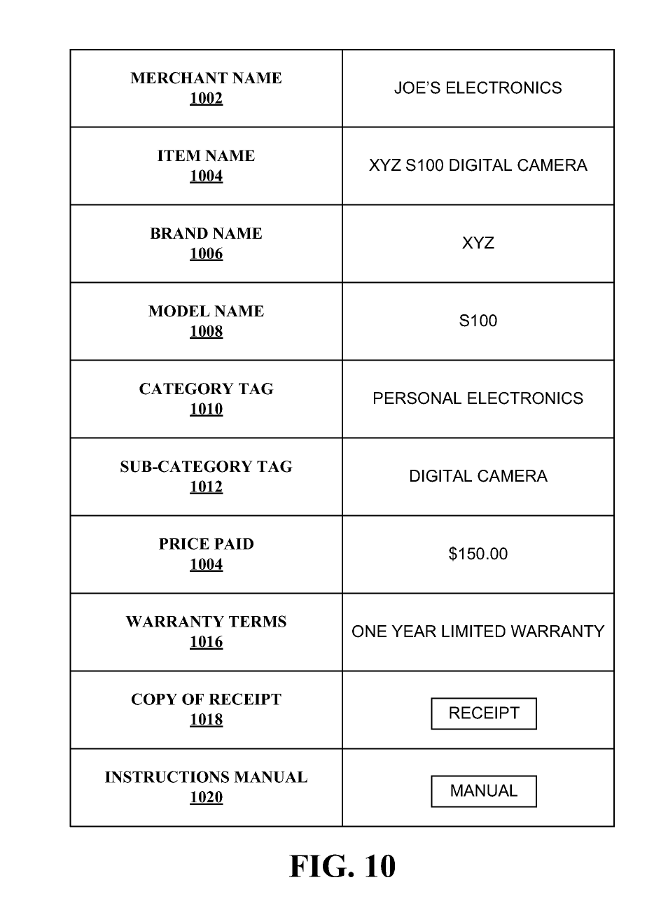

The receipt organizer module 604 retrieves data associated with the identified item from the library 602 and associates the retrieved data with the record of the financial transaction (e.g., receipt). For example, the receipt organizer module 604 associates warranty terms, a specification, and a manual with the identified item in the corresponding receipts. The receipt organizer module 604 then stores the organized information in a database such as the database 128. An example of a data structure of the stored organized information is further illustrated below with respect to FIG. 10.

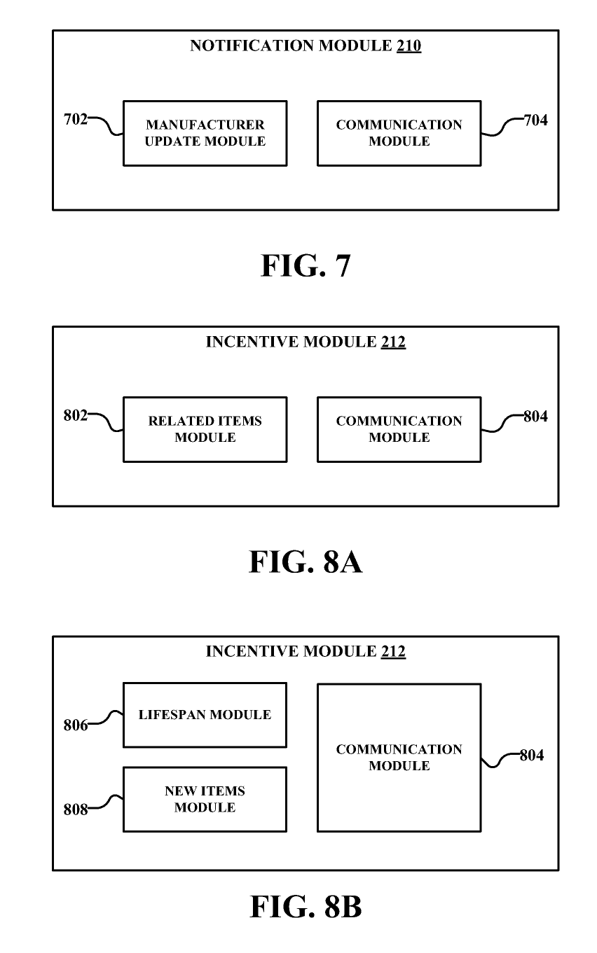

FIG. 7 is a block diagram illustrating an example embodiment of the notification module 210. The notification module 210 notifies the user of updated data concerning the identified item. The notification module 210 has a manufacturer update module 702 and a communication module 704. The manufacturer update module 702 retrieves recently updated data (e.g., recalls, new product versions, updates, and so forth) on the identified item from a manufacturer of the identified item or from another source (e.g., government, third party). The communication module 704 communicates the updated data on the identified item to the user of the mobile device 132.

FIG. 8A is a block diagram illustrating an example embodiment of the incentive module 212. The incentive module 212 retrieves an incentive for an item related to an identified item in the record of the financial transaction. An incentive may include for example, a sale, discount, promotion, special, or recommendation. The item may be related to the identified item, for example, in a complementary manner. For example, batteries, camera bags, lenses, tripods may be related to a purchased digital camera. In one embodiment, the related items include accessories. In another embodiment, the related items include items from other related categories. For example, a chair may be related to a desk or a lamp. A related item module 802 searches for an incentive for an item related to the identified item. For example, a retrieved incentive may be a notification of a sale on a printer when the identified purchased item is a desktop computer. A communication module 804 communicates the incentive for the related item to user of the mobile device 132.

FIG. 8B is a block diagram illustrating another example embodiment of the incentive module 212. The incentive module 212 retrieves an incentive for an updated item of the identified item. A lifespan module 806 estimates the useful life of the identified item or the average refresh cycle for a product similar to the identified item. For example, the lifespan module 806 may estimate that a mobile telephone device is used by the same user for an average of 15 months using statistics and data obtained from internal/external sources. A new item module 808 searches for a new item related to the identified item prior to the end of the useful life of the identified item. For example, prior to the end of the 15 month average usage for a mobile telephone, the new item module 808 searches for a new model/version of the purchased mobile telephone and communicates or recommends the new mobile telephone to the user with the communication module 804. In another embodiment, the new item module 808 may search for an incentive for a related item to the purchased item. For example, the new item module 808 may notify the user of a special discount on another brand of mobile telephone around or prior to the end of the average usage life of the purchased mobile telephone.

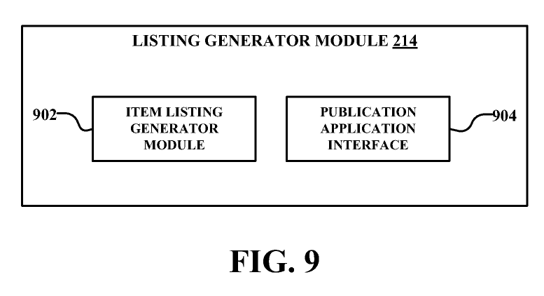

FIG. 9 is a block diagram illustrating an example embodiment of a listing generator module 214. A listing module 214 generates a listing of the identified item to the publication application 124. An item listing generator 902 generates the listing of a purchased item in the inventory of the user based on the records of the financial transaction and the corresponding data. For example, a user may decide to sell an item from his/her inventory. The user can select which purchased item to list. The item listing generator 902 retrieves the brand name, model number, age of the selected item and generates a listing (e.g., advertisement) for an marketplace (e.g., online ads, or auction websites). The item listing generator 902 may retrieve one or more images, either stored in the centrally maintained inventory list or stored separately in a database, associated with the item for inclusion in the listing. A publication application interface 904 communicates the listing of the selected item for sale to the publishing application 124. The centrally maintained inventory of items owned by the user thus enables the user to easily determine what items the user owns and what items the user desires to sell via the listing module 214.

FIG. 10 is a block diagram illustrating attributes of a data structure 1000 generated by receipt organizer 604. The data structure 1000 may include, and is not limited to, a merchant name 1002, an item name 1004, a brand name 1006, a model name 1008, a category tag 1010, a sub-category tag 1012, a purchase price 1014, warranty terms 1016, a picture of the receipt 1018, and an instruction manual 1020. A non-limiting list of other attributes stored in the data structure may include one or more images or links to images of the item, a purchase date, a location of purchase, an item identifier (e.g., a UPC barcode), rebate information, a color of the item, the dimensions of the item, and a return policy associated with the merchant and the item.

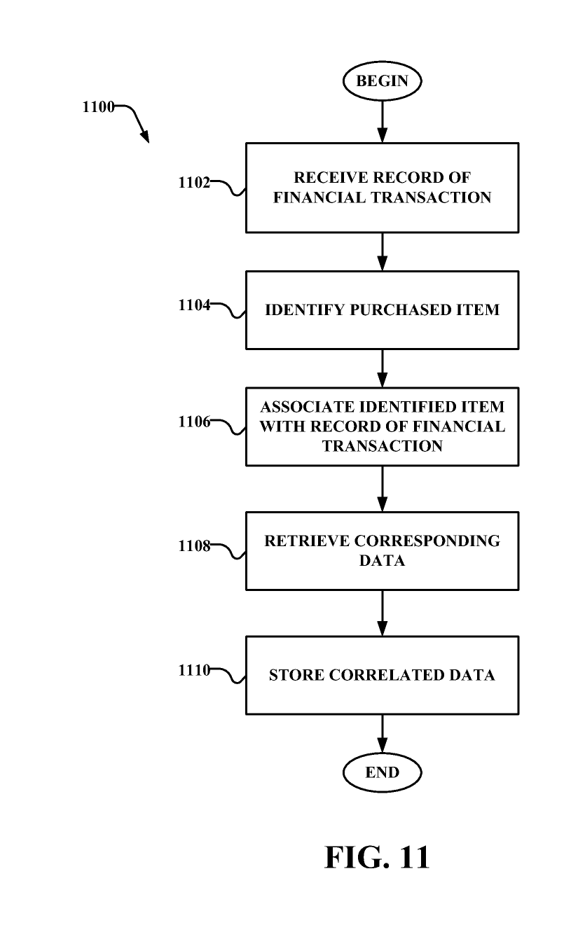

FIG. 11 is a flow chart of an example method for storing a record of a financial transaction. At 1102, a record of a financial transaction is received from a mobile device. At 1104, a purchased item is identified. The item may be identified based on a text input from a user at the geographic location of the mobile device, an audio input from the user at the geographic location of the mobile device, a machine-readable symbol scanned by the user at the geographic location of the mobile device, an image taken by the user at the geographic location of the mobile device, or a video taken by the user at the geographic location of the mobile device.

At 1106, the identified item is associated with the record of the financial transaction. At 1108, data (e.g., warranty terms, specifications, and so forth) corresponding to the identified item is retrieved from a library of items catalog. At 1110, the correlated data (record of the financial transaction associated with the identified item along with the corresponding data) are stored in a storage device (e.g., a networked storage server).

In another embodiment, the location of the mobile device is determined and associated with the record of the financial transaction. Alternatively, the location of where the item was purchased can be determined from a copy of the receipt. The geographic location of the financial transaction may be determined based on the geographic location of the mobile device. The geographic location of the financial transaction may be based on a triangulation service or a GPS service of the mobile device, a user input at the mobile device, a location-dependent search term user input at the mobile device, a tag received at the mobile device, or the tag associated with a unique geographic location.

In another embodiment, a scanned copy of the receipt, an email of the receipt, a user input of the receipt may be received and stored along with the record of the financial transaction.

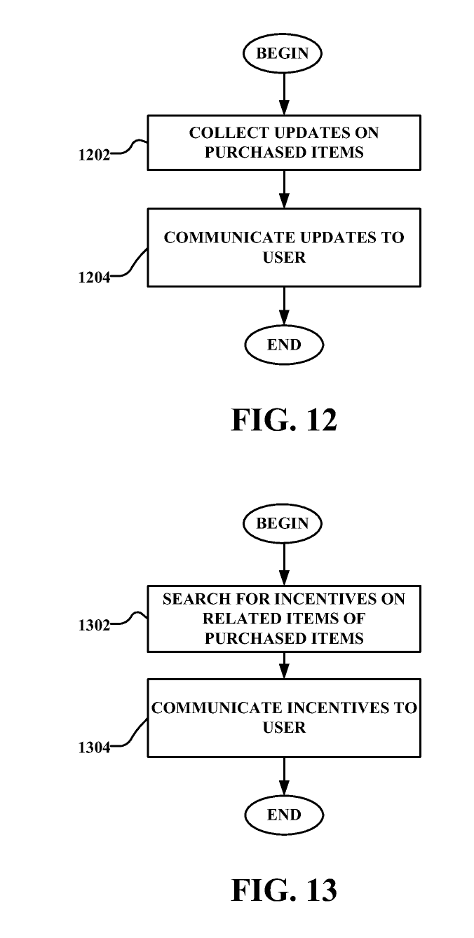

FIG. 12 is a flow chart of an example method for communicating updates. At 1202, the updated data on the identified item is retrieved from a manufacturer of the identified item. The identified item (or identifying information related to the item) may be transmitted to the manufacturer of the item and used as a search query to retrieve updated data related to the item. Alternatively, the item may be registered with the manufacturer, for example, at the time of purchase, and the updated data may be automatically sent to the device storing the financial transaction and item information. At 1204, the updated data on the identified item is communicated to the mobile device.

FIG. 13 is a flow chart of an example method for communicating incentives. At 1302, the incentive module 802 searches for an incentive for an item related to the identified item. At 1304, the incentive for the related item is communicated to the mobile device. In another embodiment, the incentive module 802 communicates with a publishing application to provide an incentive to the user to generate a listing for an item from his inventory. For example, the publication application determines that there is a shortage of a particular mobile device listed. The incentive module 802 verifies that the user owns the particular mobile device and then generates an incentive to the user to generate a listing of the particular mobile device with the publication application.

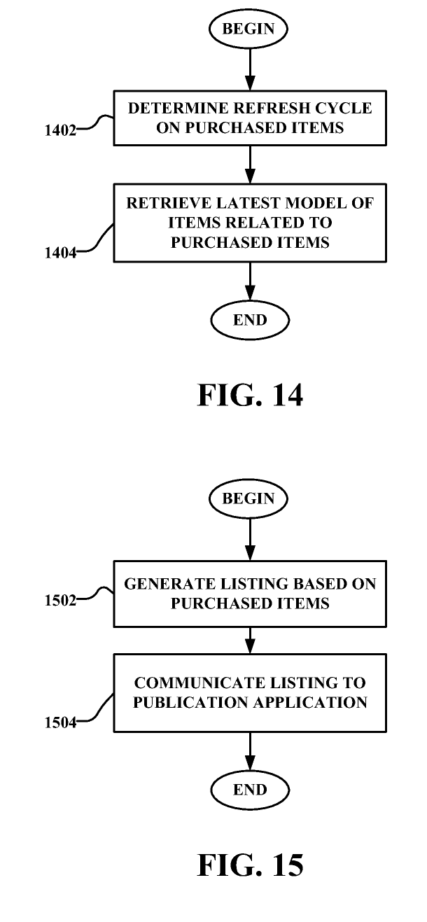

FIG. 14 is a flow chart of another example method for communicating incentives. At 1402, the useful life (product life cycle) of the identified item is estimated. At 1404, a listing of a new item (new version) related to the identified item is retrieved prior to the end of the useful life of the identified item. At 1406, the new item listing is communicated to the mobile device to enable the user to upgrade the item to the newer item if desired.

FIG. 15 is a flow chart of an example method for generating a listing. At 1502, a listing of the identified item is generated based on the record of the financial transaction and the corresponding data. As described above, the listing may be populated with item metadata obtained or extracted from the financial transaction data and the corresponding data. The accuracy and ease of generating the listing may be improved as the user does not have to manually enter data for the item listing. At 1504, the listing of the identified item is communicated to the publishing application.

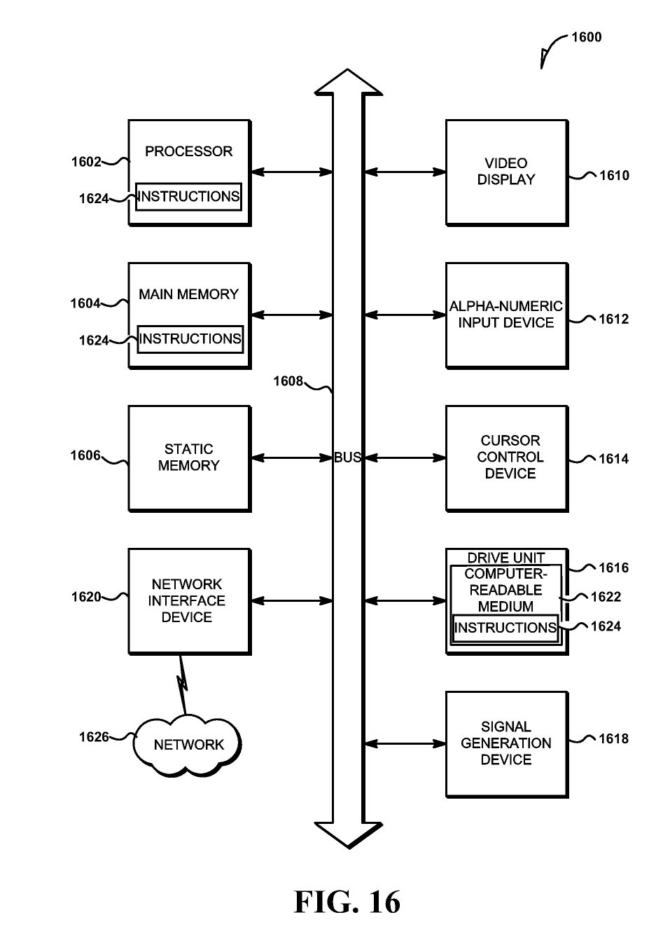

FIG. 16 shows a diagrammatic representation of machine in the example form of a computer system 1600 within which a set of instructions may be executed causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1600 includes a processor 1602 (e.g., a central processing unit (CPU), a graphics processing unit (GPU) or both), a main memory 1604 and a static memory 1606, which communicate with each other via a bus 1608. The computer system 1600 may further include a video display unit 1610 (e.g., a liquid crystal display (LCD) or a cathode ray tube (CRT)). The computer system 1600 also includes an alphanumeric input device 1612 (e.g., a keyboard), a user interface (UI) navigation device 1614 (e.g., a mouse), a disk drive unit 1616, a signal generation device 1618 (e.g., a speaker) and a network interface device 1620.

The disk drive unit 1616 includes a machine-readable medium 1622 on which is stored one or more sets of instructions and data structures (e.g., software 1624) embodying or utilized by any one or more of the methodologies or functions described herein. The software 1624 may also reside, completely or at least partially, within the main memory 1604 and/or within the processor 1602 during execution thereof by the computer system 1600, the main memory 1604 and the processor 1602 also constituting machine-readable media.

The software 1624 may further be transmitted or received over a network 1626 via the network interface device 1620 utilizing any one of a number of well-known transfer protocols (e.g., HTTP).

While the machine-readable medium 1622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical media, and magnetic media.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A system, comprising:
a processor-implemented receipt module configured to receive a record of a financial transaction from a mobile device;
a processor-implemented item identification module configured to identify an item from the record of the financial transaction;
a processor-implemented catalog module configured to retrieve data corresponding to the identified item; and
a storage device configured to store the record of the financial transaction associated with the identified item along with the corresponding data.

2. The system of claim 1 wherein the processor-implemented receipt module comprises at least one of:
a processor-implemented email module configured to receive an email comprising a receipt of the financial transaction;
a processor-implemented scan module configured to receive a digital image of the receipt; and
a processor-implemented input module configured to receive a user input of the receipt.

3. The system of claim 1 further comprising:
a processor-implemented location identification module configured to determine the geographic location of the financial transaction based on the geographic location of the mobile device, wherein the storage device is configured to store the geographic location of the financial transaction with the corresponding record,
wherein the processor-implemented location identification module comprises at least one of:
a processor-implemented triangulation service or a global positioning service (GPS) configured to determine the location of the mobile device based on a triangulation service or a GPS service;
a processor-implemented location input module configured to determine the location of the mobile device based on a user input at the mobile device;
a processor-implemented location-dependent search term input module configured to determine the location of the mobile device based on a location-dependent search term user input at the mobile device; and
a processor-implemented tag module configured to determine the location of the mobile device based on a tag received at the mobile device, the tag associated with a unique geographic location.

4. The system of claim 1 wherein the processor-implemented item identification module comprises at least one of:
a processor-implemented text identification module configured to identify the item based on a text input from a user of the mobile device;
a processor-implemented audio identification module configured to identify the item based on an audio input from the user of the mobile device;
a processor-implemented machine-readable symbol module configured to identify the item based on a machine-readable symbol scanned by the user of the mobile device;
a processor-implemented image identification module configured to identify the item based on an image taken by the user of the mobile device; and
a processor-implemented video identification module configured to identify the item based on a video taken by the user of the mobile device.

5. The system of claim 1 wherein the catalog module further comprises:
a library of items configured to store data associated with corresponding items; and
a receipt organizer module configured to retrieve data associated with the identified item from the library of items and to associate the retrieved data with the record of the financial transaction.

6. The system of claim 1 further comprising:
a processor-implemented notification module configured to notify the mobile device of updated data concerning the identified item,
wherein the processor-implemented notification module comprises at least one of:
a processor-implemented manufacturer update module configured to retrieve the updated data concerning the identified item from a manufacturer of the identified item; and
a processor-implemented communication module configured to communicate the updated data concerning the identified item to the mobile device.

7. The system of claim 1 further comprising:
a processor-implemented incentive module configured to retrieve an incentive for an item related to the identified item,
wherein the processor-implemented incentive module comprises at least one of:
a processor-implemented related item module configured to search for an incentive for an item related to the identified item; and
a processor-implemented communication module configured to communicate the incentive for the related item to the mobile device.

8. The system of claim 1 further comprising:
a processor-implemented incentive module configured to retrieve an incentive for an item related to the identified item,
wherein the processor-implemented incentive module comprises at least one of:
a processor-implemented lifespan module configured to estimate the useful life of the identified item;
a processor-implemented new item module configured to search for a new item related to the identified item prior to the end of the useful life of the identified item; and
a processor-implemented communication module configured to communicate a listing for the new item to the mobile device.

9. The system of claim 1 further comprising:
a processor-implemented listing module configured to generate a listing of the identified item to a publishing application,
wherein the processor-implemented listing module comprises at least one of:
a processor-implemented item listing generator configured to generate the listing of the identified item based on the record of the financial transaction and the corresponding data; and
a processor-implemented publishing application interface configured to communicate the listing of the identified item to the publishing application.

10. A computer-implemented method comprising:
receiving a record of a financial transaction from a mobile device;
identifying an item from the record of the financial transaction;
retrieving data corresponding to the identified item; and
storing the record of the financial transaction associated with the identified item along with the corresponding data in a storage device.

11. The computer-implemented method of claim 10 wherein receiving the record of the financial transaction further comprises receiving at least one of an email of a receipt of the financial transaction, a digital image of the receipt, and a user input of the receipt.

12. The computer-implemented method of claim 10 further comprising:
determining the geographic location of the financial transaction based on the geographic location of the mobile device, wherein the storage device is configured to store the geographic location of the financial transaction with the corresponding record,
wherein determining the geographic location of the financial transaction is based on at least one of a triangulation service or a GPS service of the mobile device, a user input at the mobile device, a location-dependent search term user input at the mobile device, a tag received at the mobile device, and the tag associated with a unique geographic location.

13. The computer-implemented method of claim 10 further comprising:
identifying the item based on at least one of a text input from a user at the geographic location of the mobile device, an audio input from the user at the geographic location of the mobile device, a machine-readable symbol scanned by the user at the geographic location of the mobile device, an image taken by the user at the geographic location of the mobile device, and a video taken by the user at the geographic location of the mobile device.

14. The computer-implemented method of claim 10 further comprising:
storing data corresponding to items in a library of items;
retrieving data associated with the identified item from the library of items; and
associating the retrieved data with the record of the financial transaction.

15. The computer-implemented method of claim 10 further comprising:
notifying the mobile device of updated data concerning the identified item,
wherein the notifying comprises retrieving the updated data concerning the identified item from a manufacturer of the identified item, and communicating the updated data concerning the identified item to the mobile device.

16. The computer-implemented method of claim 10 further comprising:
retrieving an incentive for an item related to the identified item,
wherein the retrieving comprises searching for an incentive for an item related to the identified item and communicating the incentive for the related item to the mobile device.

17. The computer-implemented method of claim 10 further comprising:
retrieving an incentive for an item related to the identified item,
wherein the retrieving comprises estimating the useful life of the identified item, searching for a new item related to the identified item prior to the end of the useful life of the identified item, and communicating a listing of the new item to the mobile device.

18. The computer-implemented method of claim 10 further comprising:
generating a listing of the identified item to a publishing application,
wherein the generating comprises generating the listing of the identified item based on the record of the financial transaction and the corresponding data, and communicating the listing of the identified item to the publishing application.

19. A non-transitory computer-readable storage medium storing a set of instructions that, when executed by a processor, causes the processor to perform operations, comprising:
receiving a record of a financial transaction from a mobile device;
identifying an item from the record of the financial transaction;
retrieving data corresponding to the identified item; and
storing the record of the financial transaction associated with the identified item along with the corresponding data in a storage device.

20. The non-transitory computer-readable storage medium of claim 19 wherein receiving the record of the financial transaction further comprises receiving at least one of an email of a receipt of the financial transaction, a digital image of the receipt, and a user input of the receipt.

21. The non-transitory computer-readable storage medium of claim 19 further comprising:
determining the geographic location of the financial transaction based on the geographic location of the mobile device, wherein the storage device is configured to store the geographic location of the financial transaction with the corresponding record,
wherein determining the geographic location of the financial transaction is based on at least one of a triangulation service or a GPS service of the mobile device, a user input at the mobile device, a location-dependent search term user input at the mobile device, a tag received at the mobile device, and the tag associated with a unique geographic location.

22. The non-transitory computer-readable storage medium of claim 19 further comprising:
identifying the item based on at least one of a text input from a user at the geographic location of the mobile device, an audio input from the user at the geographic location of the mobile device, a machine-readable symbol scanned by the user at the geographic location of the mobile device, an image taken by the user at the geographic location of the mobile device, and a video taken by the user at the geographic location of the mobile device.

23. The non-transitory computer-readable storage medium of claim 19 further comprising:
storing data corresponding to items in a library of items;
retrieving data associated with the identified item from the library of items; and
associating the retrieved data with the record of the financial transaction.

24. The non-transitory computer-readable storage medium of claim 19 further comprising:
notifying the mobile device of updated data concerning the identified item,
wherein the notifying comprises retrieving the updated data concerning the identified item from a manufacturer of the identified item, and communicating the updated data concerning the identified item to the mobile device.

25. The non-transitory computer-readable storage medium of claim 19 further comprising:
retrieving an incentive for an item related to the identified item,
wherein the retrieving comprises searching for an incentive for an item related to the identified item and communicating the incentive for the related item to the mobile device.

26. The non-transitory computer-readable storage medium of claim 19 further comprising:
retrieving an incentive for an item related to the identified item,
wherein the retrieving comprises estimating the useful life of the identified item, searching for a new item related to the identified item prior to the end of the useful life of the identified item, and communicating a listing of the new item to the mobile device.

27. The non-transitory computer-readable storage medium of claim 19 further comprising:
generating a listing of the identified item to a publishing application,
wherein the generating comprises generating the listing of the identified item based on the record of the financial transaction and the corresponding data, and communicating the listing of the identified item to the publishing application.
